(19) United States
(12) Patent Application Publication
(10) Pub. No.: US 2009/0030809 A1
(43) Pub. Date: Jan. 29, 2009

(54) MESSAGE CONFIGURING METHOD FOR CONTROLLING PURCHASE SERVICE IN WIRELESS BROADCASTING

(75) Inventors: Joon-Ho PARK, Suwon-si (KR); Young-Jip Kim, Suwon-si (KR); Byoung-Dai Lee, Seongnam-si (KR); Kyung-Shin Lee, Suwon-si (KR); Sung-Oh Hwang, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/178,272

(22) Filed: Jul. 23, 2008

(30) Foreign Application Priority Data
Jul. 23, 2007 (KR) 73453-2007

(51) Int. Cl. G06Q 30/00

(52) U.S. Cl. 705/26

(57) ABSTRACT

Disclosed is a method for configuring a message for controlling purchase service in wireless broadcasting. When a portable terminal directly uses a corresponding service through registration without a process for purchasing a charged broadcasting service, the portable terminal directly receives a Multimedia Broadcast Multicast Service (MBMS) User ServiceID, and it is impossible to separate a GlobalPurchaseItemID and a PurchaseDataID from each other. Therefore, a purchase service list can not be known. However, according to the method herein, it is possible to separate two identifiers from each other in the portable terminal, so that it is possible to conveniently control each list regarding various types of purchased services.

### PRIORITY

This application claims priority to an application entitled “Message Configuring Method For Controlling Purchase Service In Wireless Broadcasting” filed in the Korean Industrial Property Office on Jul. 23, 2007 and assigned Serial No. 2007-73453, the contents of which are incorporated herein by reference.

### BACKGROUND OF THE INVENTION

1. Field of the Invention

The present invention relates generally to a Service & Content Protection standard, which has been established by a BCAST Work Group of Open Mobile Appliance (OMA) and is classified into a Digital Rights Management (DRM) profile and a smartcard profile, and in particular, relates to application of the standard to the smartcard profile.

2. Description of the Related Art

Currently, an OMA BCAST Service & Content Protection standard operation has been completed. The Service & Content Protection standard defines a technology about service protection and service access in order to wirelessly broadcast services. In a portable terminal, in order to access for use a charged broadcasting service, the portable terminal must undergo the procedure illustrated in FIG. 1 which illustrates signals for using a charged broadcasting service in a BCAST broadcast according to the conventional art.

As shown in FIG. 1, the portable terminal first transmits a purchase request message regarding a charged broadcasting service to a server in step S1. The purchase request message is formed in a message format defined in the OMA BCAST standard by using only two identifiers, which can distinguish a corresponding service, such as a GlobalPurchaseItemID and a PurchaseDataID.

The GlobalPurchaseItemID identifier is the only identifier which can distinguish purchase items (e.g. a charged broadcast channel) in performing an operation of purchasing or one related to a purchase. The Identifier PurchaseDataID identifier is the only identifier which can distinguish purchase data (e.g. a program in a specific broadcast channel) included in a subordinate group of the purchasing item. When the purchase request message is received, the server performs a charging operation and transmits a purchase checking message in step S2.

When the purchase checking message is received, the portable terminal transmits a registration request message for registering a corresponding service in step S3.

In the registration request message, a Multimedia Broadcast Multicast Service (MBMS) user serviceID of the service desired by the user of the portable terminal has to be clarified.

The MBMS User ServiceID is constituted of a concatenation in which are combined a GlobalPurchaseItemID and PurchaseDataID, which are used in the purchase request step S1.

When the registration request message is received, the server performs service registration, and transmits a registration identifying message in step S4. When the registration identifying message is received, the User Datagram Protocol (UDP) session is opened between the portable terminal and server, and an encoding key is transmitted from the server to the portable terminal by using a UDP protocol in step S5.

The encoding key may be a Service Encryption Key (SEK) or a Program Encryption Key (PEK) defined in BCAST standards. A code formed in video/audio data of a broadcast service can be decoded by using this encoding key.

The encoding key can be stored in a Subscriber Identity Module (SIM) card of the portable terminal, and the portable terminal receiving the encoding key accesses a charged broadcasting service, and can finally use a corresponding service, such as watching TeleVision (TV).

In the portable terminal, in order to control a purchase service list, the two identifiers, i.e. the GlobalPurchaseItemID and the PurchaseDataID, have to be used. However, in the business model in which a purchasing process is omitted, since the portable terminal immediately receives an MBMS User ServiceID from the server, it is impossible to distinguish two identifiers. Therefore, there is a problem in that the purchase service list cannot be controlled.

### SUMMARY OF THE INVENTION

Accordingly, the present invention has been made to solve the above-mentioned problems occurring in the prior art, and the present invention provides a message configuring method for combining a GlobalPurchaseItemID and a PurchaseDataID constituting MBMS User ServiceID and separating them from each other later.

According to the present invention, provided is message configuring method for controlling a purchase service list in wireless broadcast, in which a discriminator is inserted between a first identifier and a second identifier for distinguishing a corresponding service to be purchased, so as to configure an IDentification (ID) of a purchase service.

According to the present invention, provided is a method for transmitting a purchase service ID, the method including requesting service registration from a server by a portable terminal, configuring an ID of the service requested to be registered in such a manner that the server inserts a discriminator into a first identifier and a second identifier for distinguishing the service requested to be registered, and transmitting the ID of the service requested to be registered to the portable terminal.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a flow of signals for using a charged broadcasting service in BCAST broadcast, according to the conventional art;

FIG. 2 illustrates the construction of an MBMS User ServiceID according to a first embodiment of the present invention; and

FIG. 3 illustrates the construction of an MBMS User ServiceID according to a second embodiment of the present invention.

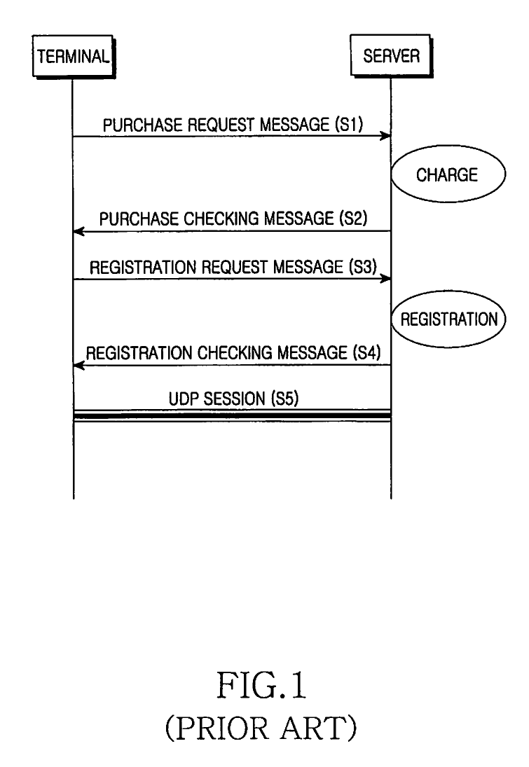

### DETAILED DESCRIPTION OF THE PREFERRED EMBODIMENTS

The matters defined in the description such as a detailed construction and elements are provided to assist in a comprehensive understanding of preferred embodiments of the invention. Accordingly, those of ordinary skill in the art will recognize that various changes and modifications of the embodiments described herein can be made without departing from the scope and spirit of the invention. Also, descriptions of well-known functions and constructions are omitted herein for the sake of clarity and conciseness.

The Uniform Resource Identifier (URI) of any American Standard Code for Information Interchange (ASCII) string is possible in a GlobalPurchaseItemID and a PurchaseDataID defined in BCAST standards. Therefore, in a situation where it is possible to know which type of service a portable terminal purchased, tow identifiers cannot be distinguished through only a scheme in which a discriminator is positioned between two identifiers.

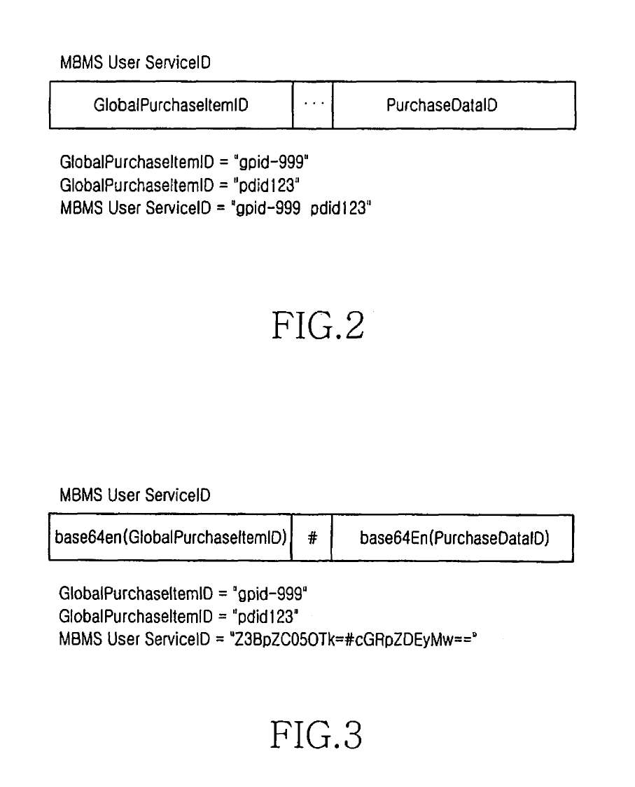

FIG. 2 illustrates the construction of an MBMS User ServiceID according to a first embodiment of the present invention. In FIG. 2, a GlobalPurchaseItemID and a PurchaseDataID are separated blank characters.

According to World Wide Web Consortium definition of any URI form, it is impossible to use blank characters in the URI. Therefore, the blank character is inserted between two character row of the any URI form in order to serpeate two of character row of any URI when two of character row of the any URI are combined. That is, if a discriminator such as a blank character (‘ ’) is inserted between the GlobalPurchaseItemID and the PurchaseDataID, the GlobalPurchaseItemID and the PurchaseDataID can later be separated from the MBMS User ServiceID.

In FIG. 2, when the GlobalPurchaseItemID is “gpid-999”, and the PurchaseDataID is “pdid123”, if values of two identifiers are combined while being distinguished by a blank character, the MBMS User ServiceID becomes “gpid-999 pdid123.” In the portable terminal, the two identifiers can be distinguished and separated from each other based on the blank character.

FIG. 3 illustrates the construction of an MBMS User ServiceID according to a second embodiment of the present invention. In FIG. 3 is shown an example where the GlobalPurchaseItemID and the PurchaseDataID are separated from each other by a specific character.

In the second embodiment, each of the GlobalPurchaseItemID and the PurchaseDataID is converted through a specific encoding method, and the converted two identifiers are combined with each other so as to form an MBMS User ServiceID. At this time, a character such as a discriminator, which is not shown in a result obtained by performing the encoding method, is inserted between the converted two identifiers.

When the two identifiers are separated, since the portable terminal knows the used encoding method, if a character which does not come from an MBMS User ServiceID after encoding, is found out and recognized as a discriminator, and the two encoded identifiers are decoded based on the discriminator, the two identifiers can be separated from each other.

For example, when an encoding method Base64 is used, a character #, which has not been used during encoding, can be used as a discriminator.

In FIG. 3, when a GlobalPurchaseItemID is “gpid-999,” and a PurchaseDataID is “pdid123,” if the GlobalPurchaseItemID is encoded by the base64 encoding method, it becomes “Z3BpZC05OTk=.” Also, if the PurchaseDataID is encoded by the base64 encoding method, it becomes “cGRpZDEyMw==.”

Afterward, if values of the encoded two identifiers are combined while being distinguished by using the character #, the MBMS User ServiceID becomes “Z3BpZC05OTk=#cGRpZDEyMw==”. In the portable terminal, if two identifiers are distinguished from each other based on the character # and are decoded, respectively, the two identifiers can be separated from each other.

As is apparent from the above description, the present invention advantageously improves on the prior art by providing a message configuring method for combining a GlobalPurchaseItemID and a PurchaseDataID constituting MBMS User ServiceID and later separating them from each other, so as to better distinguish the two identifiers.

While the present invention has been shown and described with reference to certain preferred embodiments of the present invention thereof, it will be understood by those skilled in the art that various changes in form and details may be made therein without departing from the spirit and scope of the present invention as defined by the appended claims and their equivalents.

What is claimed is:

1. A message configuring method for controlling a purchase service list in wireless broadcast, the method comprising inserting a discriminator between a first identifier and a second identifier for distinguishing a corresponding service to be purchased, so as to configure an IDentifier (ID) of a purchase service.

2. The message configuring method as claimed in claim 1, wherein the discriminator is a blank character.

3. The message configuring method as claimed in claim 1, wherein the discriminator is one of characters which are not generated in encoding the first identifier and the second identifier.

4. A method for transmitting a purchase service IDentifier (ID), the method comprising the steps of:
requesting service registration from a server by a portable terminal;
configuring an ID of the service requested to be registered in such a manner that the server inserts a discriminator between a first identifier and a second identifier for distinguishing the service requested to be registered; and
transmitting the ID of the service requested to be registered to the portable terminal.

5. The method as claimed in claim 4, further comprising separating the first identifier and second identifier from each other, based on the discriminator, in the service ID, which has been received in the portable terminal.
